(19) United States
(12) Patent Application Publication
(10) Pub. No.: US 2026/0356313 A1
(43) Pub. Date: Nov. 12, 2026

(54) REAR IMPACT GUARD

(71) Applicant: STI Holdings, Inc., Stoughton, WI (US)

(72) Inventors: Scott Lubenow, Fitchburg, WI (US); Brett Wagner, Stoughton, WI (US); Thomas James Draxler, Deerfield, WI (US); Marcos A. Gonzalez Munoz, Stoughton, WI (US)

(21) Appl. No.: 19/671,133

(22) Filed: May 7, 2026

Related U.S. Application Data
(60) Provisional application No. 63/801,473, filed on May 7, 2025.

(51) Int. Cl. B60R 19/56; B60R 19/02; B60R 19/34; B62D 63/08

(52) U.S. Cl. CPC B60R 19/56; B60R 19/023; B60R 19/34; B62D 63/08

(57) ABSTRACT

A rear impact guard assembly attached to a trailer or chassis with a rear bolster. The rear impact guard assembly includes a bumper with opposite lateral ends, a post extending between the bumper and the rear bolster, a vertical stabilizer coupled to the rear bolster by a bolster bracket and coupled to the bumper by a bumper bracket; and a diagonal truss member. A first end of the diagonal truss member is coupled to the bumper bracket and extends therefrom along an axis in a forward, inward and upward direction to a second end, which is coupled to a truss bracket and the trailer or chassis. Impact load is absorbed at least in part by plastic axial compression of the diagonal truss member. A pre-impact state of the diagonal truss member has a first length, whereas a deformed post-impact state of the same has a shorter second length.

### FIELD

This application claims priority to U.S. Provisional Patent Application No. 63/801,473 filed May 7, 2025, the entire contents of which are incorporated by reference herein.

### BACKGROUND

The present disclosure relates to rear impact guard assemblies, and more particularly to rear impact guard brackets and truss members. Rear impact guards are designed to reduce the severity of a crash between a vehicle following a trailer when the following vehicle impacts the trailer. Some crashes between vehicles and trailers involve vehicles traveling forward toward stationary trailers at a location off-center (e.g., offset) from the trailer rather than being centered relative to the trailer. Rear impact guards may be required to comply with federal or other jurisdictional mandates for safety. No known rear impact guard assemblies designed to be incorporated with a chassis onto which a standard shipping container is mountable have passed Insurance Institute for Highway Safety (i.e., IIHS) standardized testing associated with 30% overlap underride protection.

### SUMMARY

In one independent aspect, a rear impact guard assembly attached to a trailer or chassis with a rear bolster extending in a lateral direction perpendicular with respect to a longitudinal direction of travel of the trailer or chassis, the rear impact guard assembly including: a bumper with opposite lateral ends; a post extending between the bumper and the rear bolster; a vertical stabilizer coupled to the rear bolster by a bolster bracket and coupled to the bumper by a bumper bracket; a diagonal truss member with a first end thereof coupled to the bumper bracket and extending therefrom along an axis in a forward, inward and upward direction to a second end thereof, which is coupled to a truss bracket and the trailer or chassis; wherein before impact between an object with the bumper, the diagonal truss member is in a pre-impact state having a first length along the axis; wherein responsive to the impact, load of the impact is absorbed at least in part by plastic axial compression of the diagonal truss member along the axis; and wherein after the impact, the diagonal truss member is in a deformed post-impact state having a second length along the axis that is shorter than the first length.

In another independent aspect, a rear impact guard assembly attached to a trailer or chassis with a rear bolster extending in a lateral direction perpendicular with respect to a longitudinal direction of travel of the trailer or chassis, the rear impact guard assembly including: a bumper with opposite lateral ends; a post extending between the bumper and the rear bolster; a vertical stabilizer coupled to the rear bolster by a bolster bracket and coupled to the bumper by a bumper bracket; a truss member with a first end thereof coupled to the bumper bracket and extending therefrom to a second end thereof, which is coupled to a truss bracket and the trailer or chassis; wherein the bumper bracket is dimensioned such that upon impact of an object with the bumper, load of the impact deforms the bumper bracket to an expanded state.

In another independent aspect, a rear impact guard assembly attached to a trailer or chassis with a rear bolster extending in a lateral direction perpendicular with respect to a longitudinal direction of travel of the trailer or chassis, the rear impact guard assembly including: a bumper; a post extending between the bumper and the rear bolster; a connector casting and a collar configured to couple an external container to the trailer or chassis; and a washer between the collar and the casting, wherein upon impact of an object with the bumper, load of the impact is configured to be distributed from the collar and through the washer to the casting to promote high retention strength between the collar and the casting.

Other aspects of the disclosure will become apparent by consideration of the detailed description and accompanying drawings.

### BRIEF DESCRIPTION OF THE DRAWINGS

FIG. 1 is a top view of a commercial cargo vehicle with a rear impact guard prior to offset rear impact with a second vehicle.

FIG. 2 is a rear perspective view of a chassis and rear impact guard.

FIG. 3 is a bottom perspective view of the rear impact guard.

FIG. 4 is an enlarged bottom perspective view taken along section 4—4 in FIG. 3.

FIG. 5 is an enlarged bottom perspective view taken along section 5—5 in FIG. 3.

FIG. 6 is an enlarged bottom perspective view taken along section 6—6 in FIG. 3.

FIG. 7 is a top plan view of the rear impact guard of FIG. 1.

FIG. 8 is a side elevation view of the rear impact guard of FIG. 1 taken along section 8—8 in FIG. 7.

FIG. 9 is a cross-sectional view of the rear impact guard taken along section line 9—9 in FIG. 7.

FIG. 10 is an enlarged cross-sectional view of the rear impact guard taken along section 10—10 in FIG. 9.

FIG. 11 is an enlarged cross-sectional view of the rear impact guard taken along section 11—11 in FIG. 9.

FIG. 12A is a top perspective view of a bolster bracket of the rear impact guard.

FIG. 12B is bottom perspective view of the bolster bracket.

FIG. 12C is an exploded view of the bolster bracket.

FIG. 12D is a side elevation view of the bolster bracket.

FIGS. 12E-12G are perspective views of the bolster bracket illustrating weld beads applied thereto.

FIG. 13A is a rear view of a diagonal truss member, a bumper bracket, and a truss bracket of the rear impact guard.

FIG. 13B is a side elevation view of the diagonal truss member, the bumper bracket, and the truss bracket.

FIG. 13C is a cross-sectional view through the diagonal truss member taken along section 13C—13C in FIG. 13B.

FIG. 13D illustrates other exemplary cross-sections for the diagonal truss member.

FIGS. 13E-13H are perspective view of the diagonal truss member illustrating weld beads applied thereto.

FIG. 14 is a perspective view of a vertical stabilizer of the rear impact guard.

FIG. 15 is a side elevation view of the vertical stabilizer of FIG. 14.

FIG. 16 is a perspective view of a bumper bracket of the rear impact guard.

FIG. 17 is a side elevation view of the bumper bracket of FIG. 16.

FIG. 18 is a perspective view of an intermediate bumper bracket of the rear impact guard.

FIG. 19 is a side elevation view of the intermediate bumper bracket of FIG. 18.

FIG. 20 is a perspective view of a truss bracket of the rear impact guard.

FIG. 21 is an end view of the truss bracket of FIG. 20.

FIG. 22 is a perspective view of a simulation of the rear impact guard after offset impact with a simulated impacting vehicle.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

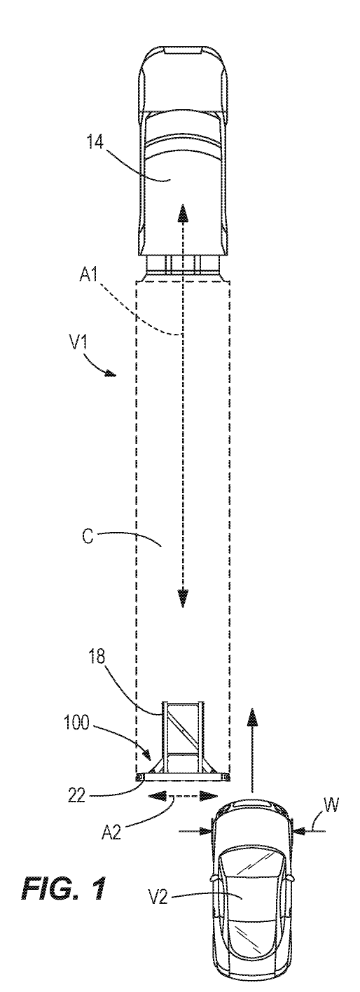

FIG. 1 illustrates a vehicle V1 with a rear impact guard 100 thereon, and an offset rear impact condition in which an impacting vehicle V2 (or other impacting object, e.g., a car) moves forwardly and crashes into the rear impact guard 100. The vehicle V1 is oriented along a longitudinal axis A1, and the rear impact guard 100 generally extends in a lateral axis A2 perpendicular to the longitudinal axis A1. In the illustrated offset rear impact condition, the impacting vehicle V2 is offset with at least a portion of its width W (e.g., 70% of the width) laterally offset along the lateral axis A2 from the vehicle V1 (with 30% of the width W aligned with the rear impact guard 100). In other straight-on rear impacts, the entire width W of the impacting vehicle V2 may be aligned with the vehicle V1. As explained in detail below, the rear impact guard 100 is coupled to the vehicle V1 to absorb impact energy of the impacting vehicle V2 and reduce the likelihood of underride of the impacting vehicle V2. The rear impact guard 100 promotes strong connection points between components thereof such that impact force of the impacting vehicle V2 is directed to desired locations designed to plastically deform and absorb energy.

The vehicle V1 may be arranged in a plurality of ways. For example, the vehicle V1 may include a tractor 14 which may be coupled to a “dry van” trailer including wheels W, a chassis 18, and a container C, or coupled with a chassis 18 with wheels W and onto which a container C is supported. The container C may be sized as an industry standard shipping container for transporting large volumes of cargo. The container C may have one or more doors for enclosing the cargo. The vehicle V1 may include the rear impact guard 100 and the container C may include or be coupled to accessory systems, for example, as a “reefer” including a refrigeration system that utilizes a power take off to utilize an engine of the tractor 14 to power hydraulic pumps of the refrigeration system. Other commercial cargo vehicles are also contemplated, including but not limited to flatbed trailers, grain trailers or “hoppers,” tanker trailers, and straight trucks wherein the truck frame supports the power plant, the cab, and an integral cargo box.

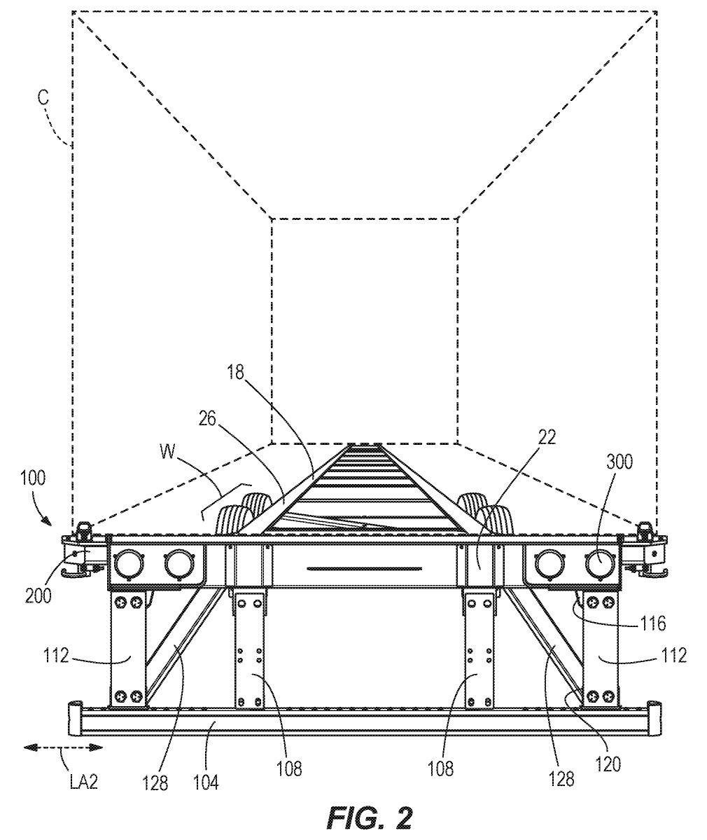

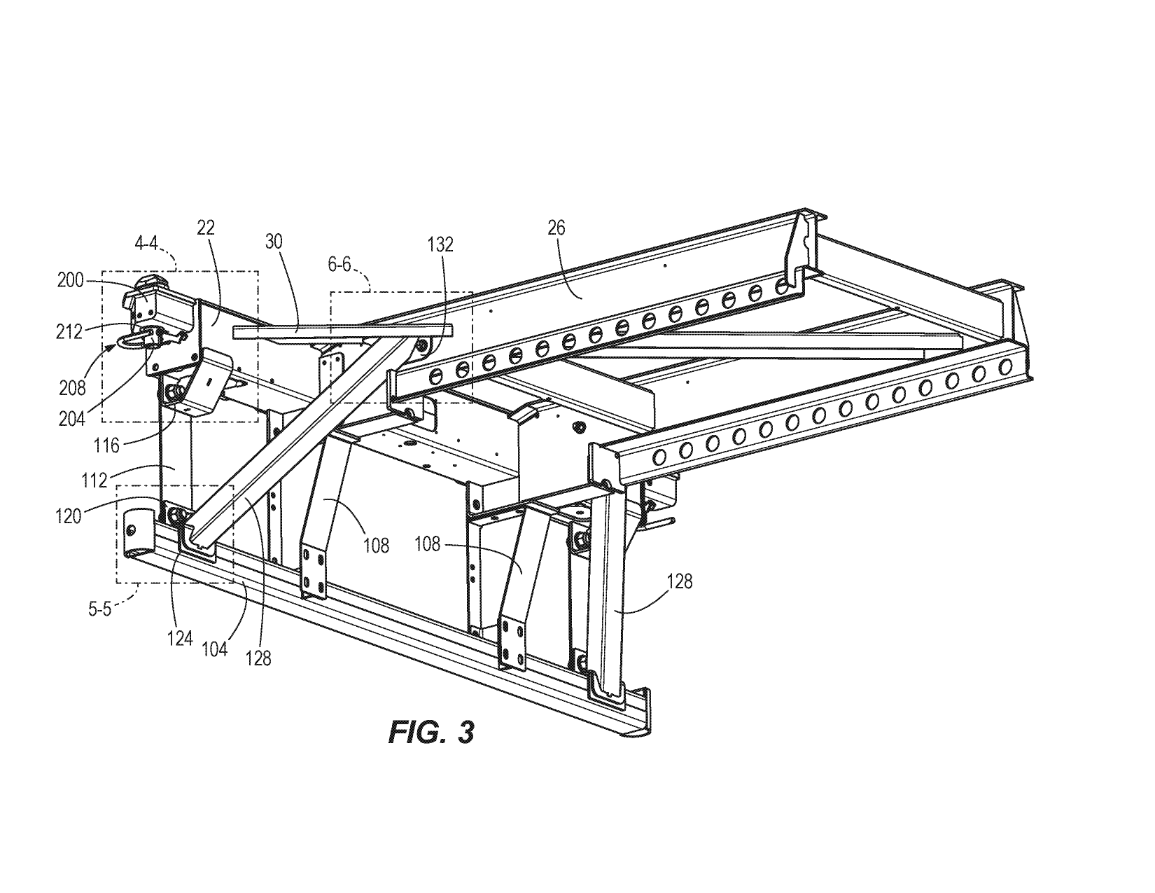

FIGS. 1 and 2 illustrate components of the vehicle V1 and the rear impact guard 100. The vehicle V1 includes a rear bolster 22 extending along a bottom rear edge and including two opposing lateral ends. The rear bolster 22 is fixed at a rear end of the chassis 18. The chassis 18 further includes two longitudinal bottom rails 26 that extend parallel to the longitudinal axis A1. Optionally, the rails 26 may be connected to the rear bolster 22 by a bolster diagonal truss member 30 (FIG. 3). The bolster diagonal truss member 30 extends forwardly and inwardly from the rear bolster 22 and to the longitudinal bottom rail 26. The wheels W engage and support the chassis 18. The tractor 14 is coupled to the chassis 18 and can drive and steer the chassis 18.

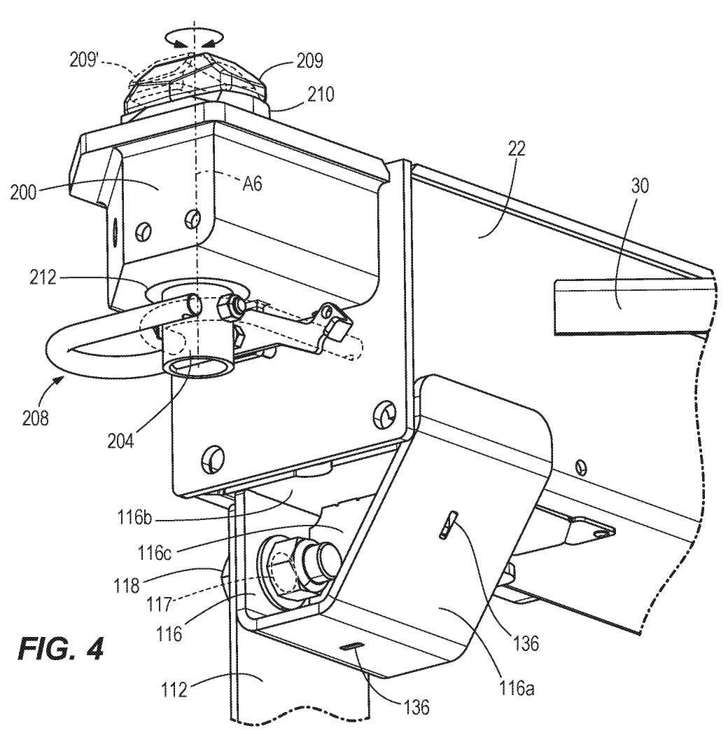

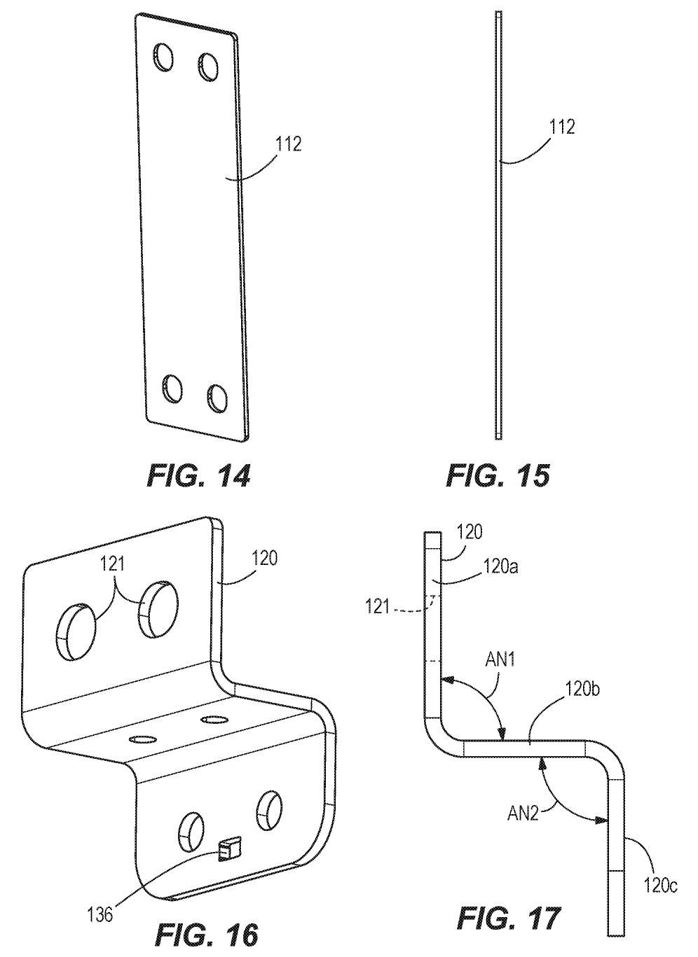

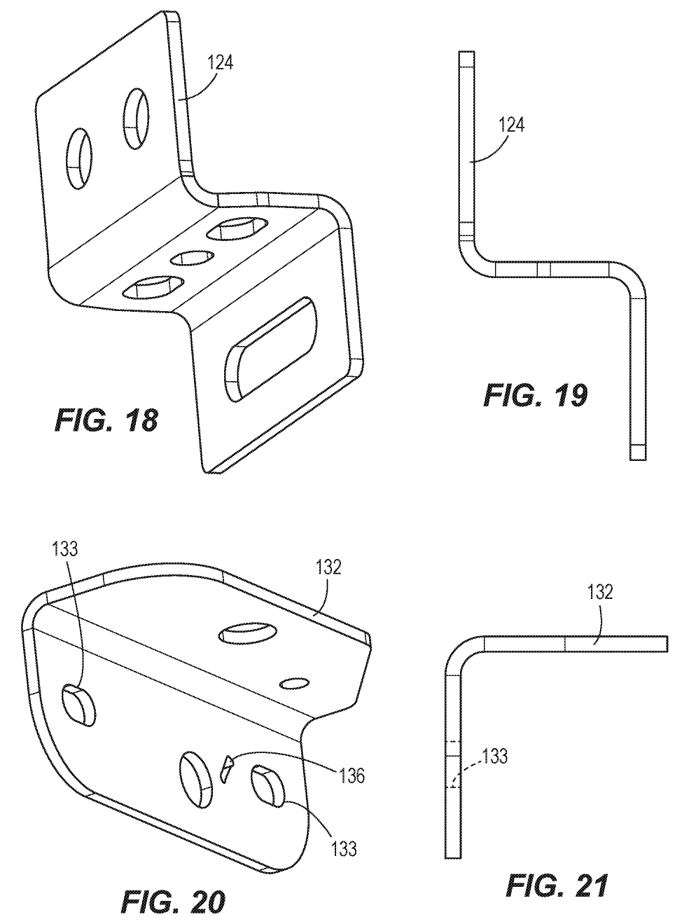

FIGS. 2-21 illustrate components of the rear impact guard 100. The rear impact guard 100 includes a bumper 104 (i.e., underride guard, Mansfield bar) extending along the lateral axis A2 below the rear bolster 22 and including first and second opposite lateral ends. Two posts 108 extend between the bumper 104 and the rear bolster 22. In the illustrated embodiment, the rear impact guard 100 includes two posts 108 positioned at intermediate lateral inboard positions in lateral alignment with the longitudinal bottom rails 26. More or fewer posts 108, or posts 108 laterally offset from the longitudinal bottom rails 26 may also be employed. The posts 108 may each be formed of one or more plates, and the plates may optionally joined together by welding, fasteners, or both. The posts 108 may be coupled to the rear bolster 22, bumper 104, and the rails 26 for transferring impact load at the bumper 104 to the chassis 18. The posts 108 may absorb axial impact load of the impacting vehicle V2 and transmit the impact load to the longitudinal bottom rails 26 and the chassis 18.

The rear impact guard 100 further includes a vertical stabilizer 112 coupled to the rear bolster 22 by a bolster bracket 116. The vertical stabilizer 112 is also coupled to the bumper 104 by a bumper bracket 120. The vertical stabilizer 112 itself can be a flat bar or plate in the shape of a strap. The vertical stabilizer 112 may be made of steel or other material. The vertical stabilizer 112 may hold up the lateral sides of the bumper 104 and assist in absorbing impact of the impacting vehicle V2 by resisting deformation of the lateral end of the bumper 104 in a longitudinally forward direction parallel to the longitudinal axis A1 at the end of the bumper 104. The vertical stabilizer 112 may be capable of elastic deformation upon lower than threshold force applied to the bumper 104. The vertical stabilizer 112 may have high tensile strength. The vertical stabilizer 112 may be capable of plastic deformation upon above threshold force and below fracture threshold force, with the plastic deformation absorbing impact force from the impacting vehicle V2. In the illustrated embodiment, one vertical stabilizer 112 is attached to each lateral side of the bumper 104. The vertical stabilizer 112 may absorb some axial impact load of the impacting vehicle V2 and transmit the impact load to the longitudinal bottom rails 26 and the chassis 18. However, the vertical stabilizer 112 is mainly designed as a support for the bumper 104.

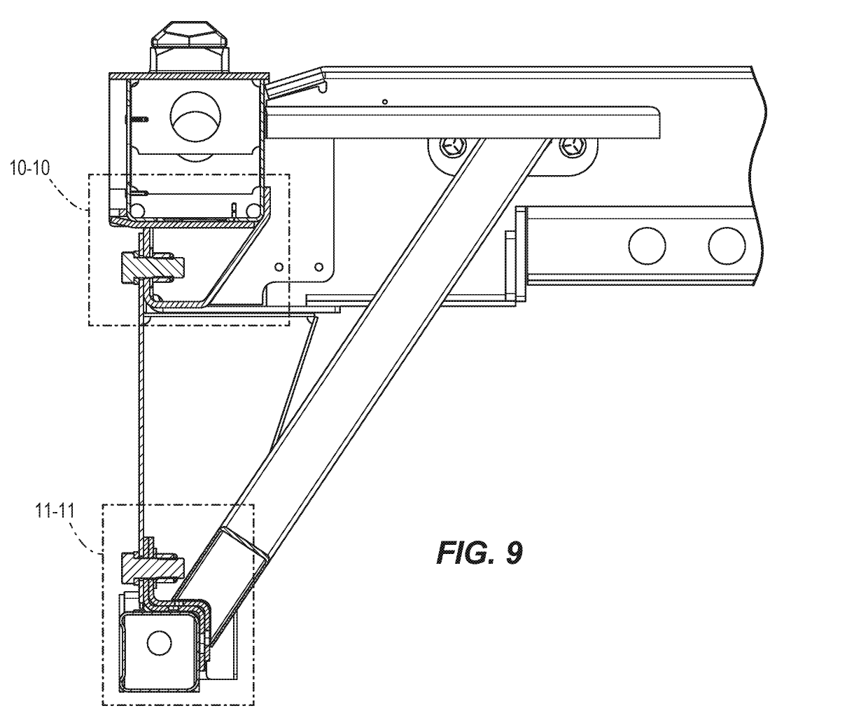

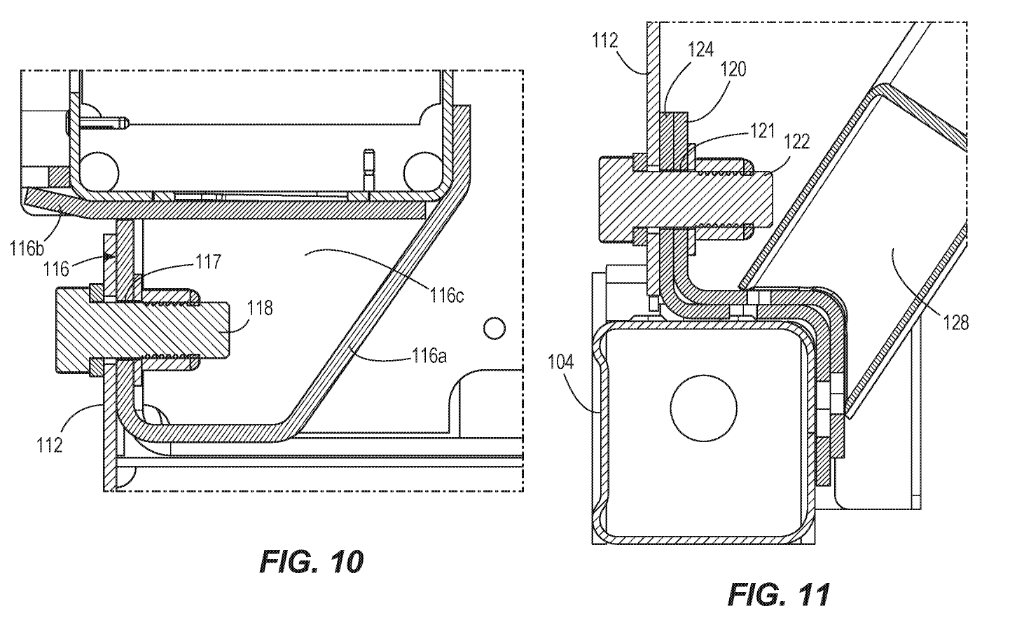

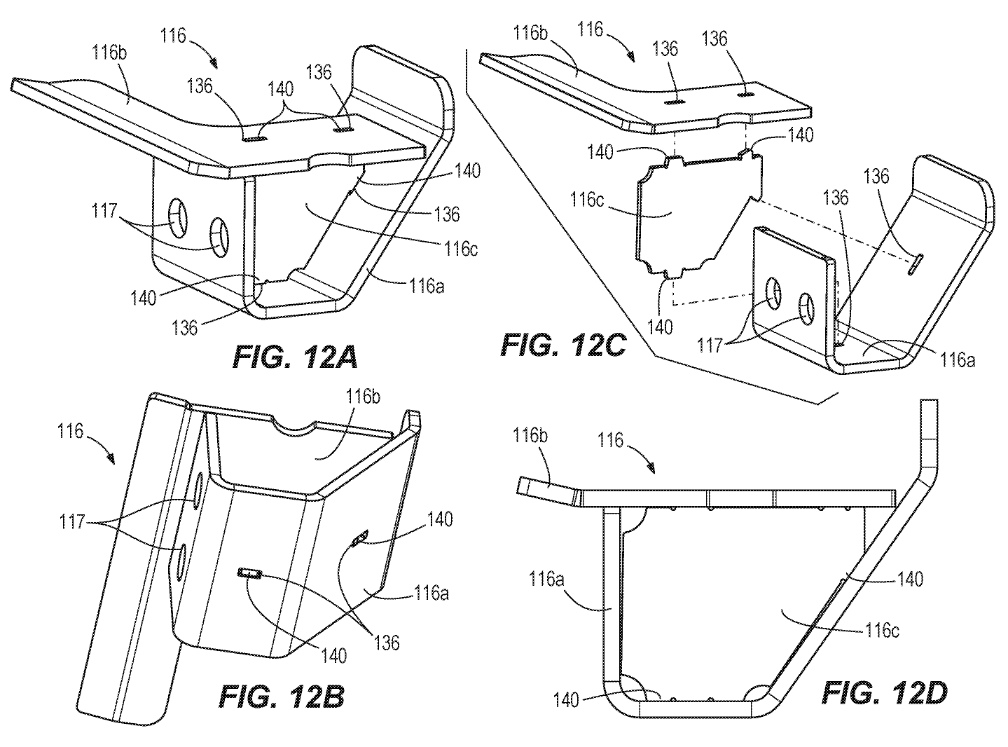

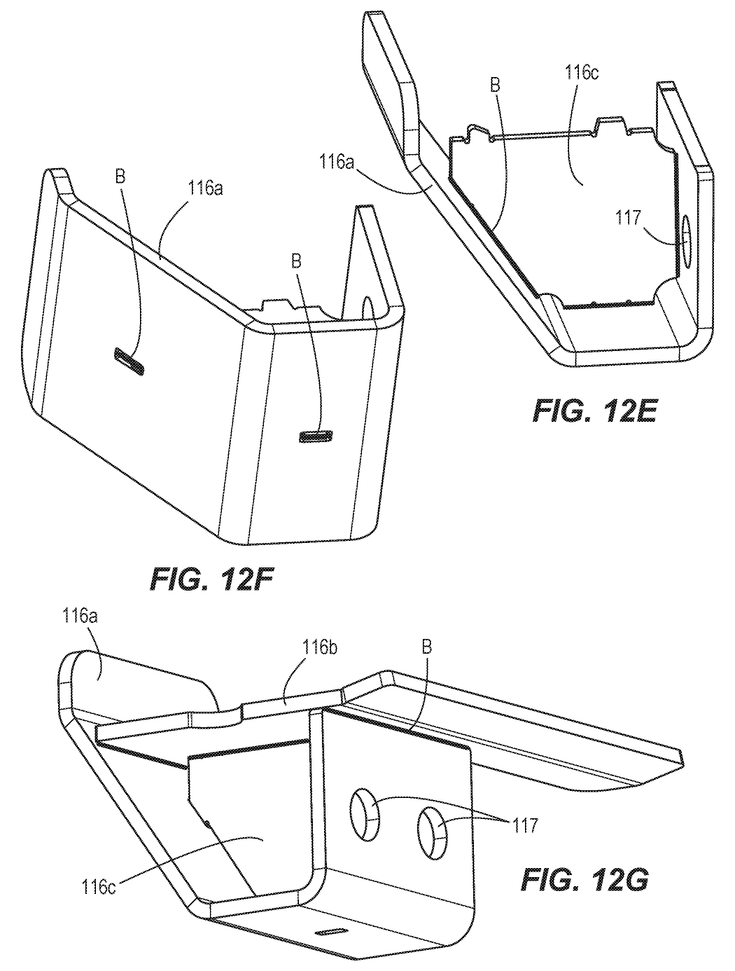

In the illustrated embodiment of FIGS. 10 and 12A-13, the bolster bracket 116 is a multi-component bracket including a plurality of interconnected plates. The bolster bracket 116 includes a first plate 116a, a second plate 116b, and a third plate 116c extending transverse to and connected to both the first plate 116a and the second plate 116b. The first plate 116a has a common cross-sectional shape extending along the lateral axis A2 which includes two vertically extending portions, a forwardly extending portion, and a diagonally extending portion (see FIGS. 12A, 12D). The first plate 116a includes holes 117 receiving fasteners 118 to secure the vertical stabilizer 112 to the bolster bracket 116. Fasteners (e.g., bolts) illustrated throughout the rear impact guard 100 may be selected at desired diameters such as 1”, 5/8”, or ¾” diameter, or the like depending on load requirements. In other embodiments, bolted joints (e.g., at the bumper 104) could be eliminated and replaced with other types of joinery (e.g., welding or the like). The rearward vertical portion abuts a forward side of the rear bolster 22, and may be secured thereto by one or more welds B. In the illustrated embodiment, the bolster bracket 116 is a separate bracket coupled with the rear bolster 22. However, in other embodiments, the bolster bracket 116 may be at least partially integrally formed as a single piece with and/or be welded to the rear bolster 22. For example, one or more of the plates 116a, 116b, 116c may be integrally formed with the rear bolster 22. In other words, the bolster bracket 116 may be a portion of the rear bolster 22, for example, to which the vertical stabilizer 112 is coupled. As illustrated in FIG. 10, the bolster bracket 116 may be bolted to the vertical stabilizer by the fastener 118. Geometry of the rear bolster 22 itself may be modified as necessary (e.g., increase in height, increase in depth, etc.) to account for the integrally formed bolster bracket 116. In such embodiments, the vertical stabilizer 112 may be integrally formed with, welded to, or bolted to the integrally formed rear bolster 22 with the bolster bracket 116.

As shown in FIG. 11, the bumper bracket 120 is dimensioned to abut upper and forwardly facing sidewalls of the bumper 104. In the illustrated embodiment, the bumper bracket 120 includes a first vertical portion 120a, a horizontal portion 120b extending forwardly from the first vertical portion 120a, and a second vertical portion 120b. The first vertical portion 120a is configured to abut the vertical stabilizer 112. The forwardly extending portion 120b is dimensioned to rest atop a top surface of the bumper 104. Finally, the second vertical portions 120c is dimensioned to abut a forwardly facing surface of the bumper 104. The first vertical portion 120a includes holes 121 receiving fasteners 122 to secure the bumper bracket 120 to the vertical stabilizer 112. However, in some embodiments, the vertical stabilizer may be integrally formed as a single piece and/or be welded to the bumper bracket 120. The second vertical portion first and second vertical portions 120c may engage the bumper 104 by welding or another connection. In the illustrated embodiment, the first vertical portion 120a is angled relative to the forwardly extending portion 120b by an angle AN1 and the second vertical portion 120b is angled relative to the forwardly extending portion 120b by an angle AN2. The illustrated embodiment provides 90 degree angles AN1, AN2. However, the bumper bracket 120 may be modified in other embodiments not to provide exactly vertical portions 120a, 120c, and an exactly horizontal forwardly extending portion 120b. In other words, the angles AN1, AN2 may differ in other embodiments.

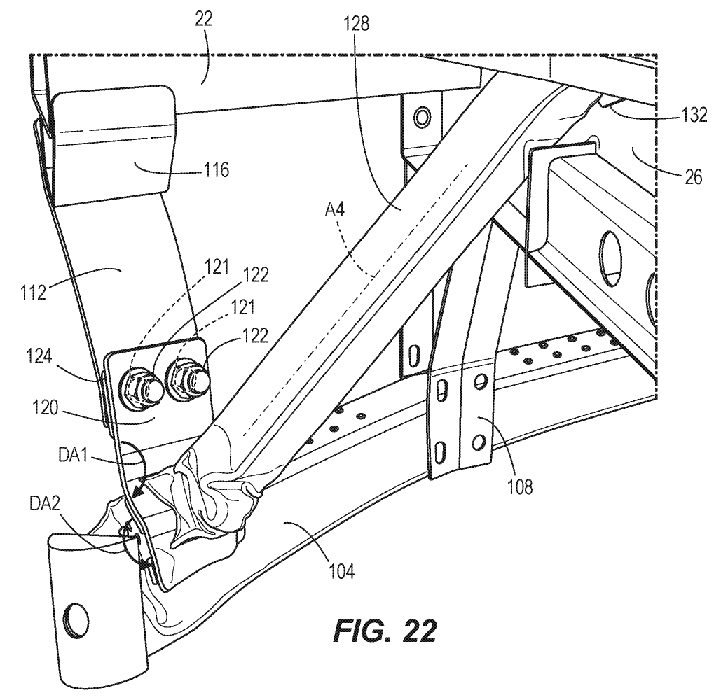

Optionally, the rear impact guard 100 may include an intermediate bumper bracket 124 between the bumper bracket 120 and the bumper 104. Inclusion of the intermediate bumper bracket 124 may allow for impact loads to cause at least one of the bumper bracket 120 and the intermediate bumper bracket 124 to deform (i.e., “open up” or be “unfolded”) between the vertical stabilizer 112, the intermediate bumper bracket 124, and the bumper bracket 120 as noted below with respect to FIGS. 17 and 22. This multi-plate design may promote shear transfer between the bumper bracket 120 and the intermediate bumper bracket 124 to promote transfer of impact loads to bending rather than cracking. Optionally, the bumper bracket 120 and the intermediate bumper bracket 124 may be coupled to one another by welding and/or other joining processes. In other embodiments, more than one (e.g., two, three, or more) intermediate bumper brackets 124 may be provided between the bumper bracket 120 and the bumper 104. In other embodiments, the rear impact guard 100 may secure the bumper bracket 120 to the bumper 104 and the vertical stabilizer 112 without an intermediate bumper bracket 124. For example, the bumper bracket 120 and the vertical stabilizer 112 may be integrally formed as a single piece and/or be welded to one another or otherwise secured (e.g., bolted) to one another. Further, in some embodiments, the bumper bracket 120 may be secured to the bumper 104 without an intermediate bumper bracket 124. For example, the bumper bracket 120 and the bumper 104 may be integrally formed as a single piece and/or welded to one another or othwerwise secured (e.g., bolted) to one another. In such embodiments, thickness of the bumper bracket 120 and/or bumper 104 may be altered to achieve desired energy absorption and transmission. In yet other embodiments, the bumper bracket 120 may extend to integrally form the vertical stabilizer 112 that connects to the rear bolster 22. This reduces the overall part count as well as the number of bolt joints during manufacture.

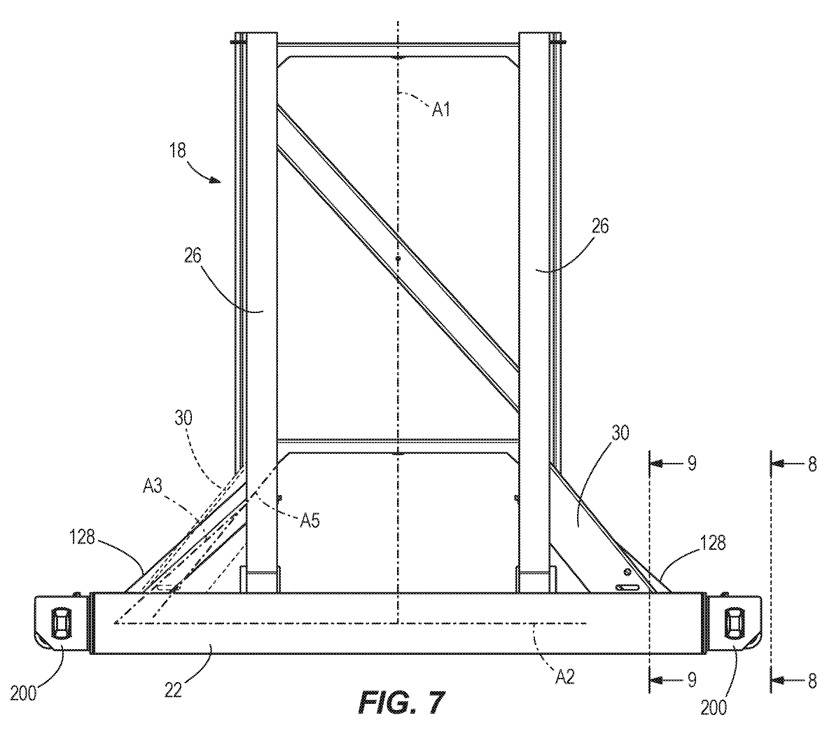

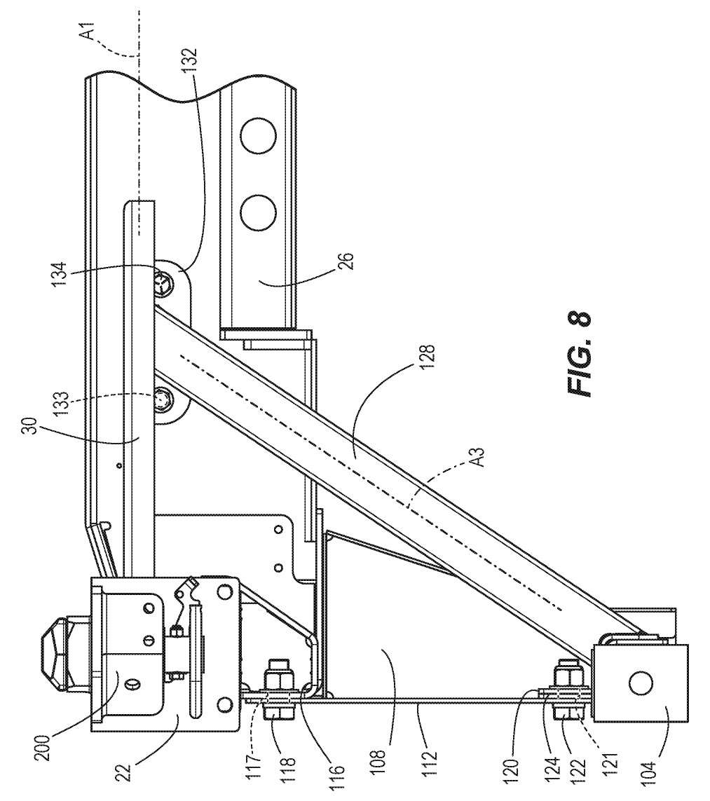

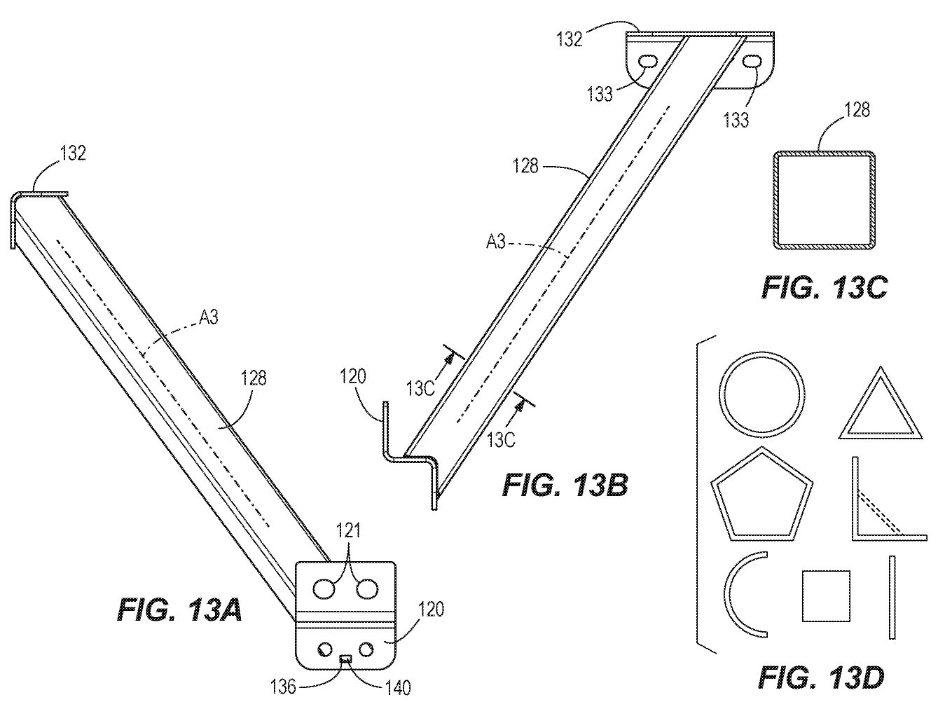

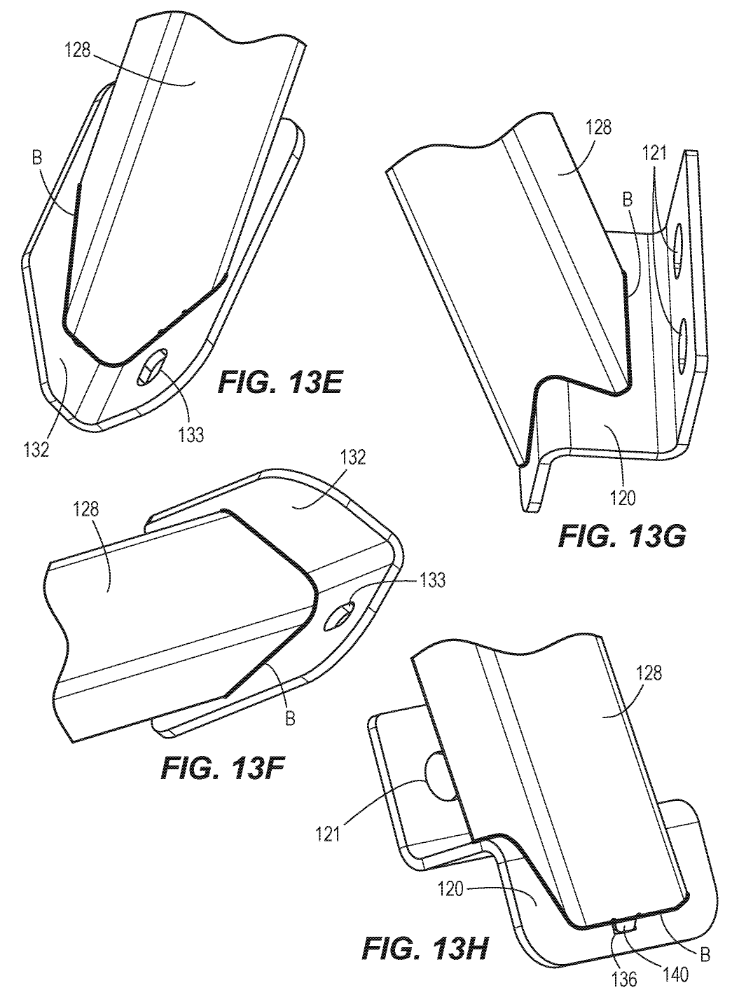

The rear impact guard 100 further includes a diagonal truss member 128 with a first end thereof coupled to the bumper bracket 120 and extending therefrom along an axis A3 (FIGS. 7 and 8) in a forward, inward and upward direction to a second end thereof, which is coupled to a truss bracket 132 and ultimately the longitudinal bottom rail 26 of the trailer or chassis 18. The truss bracket 132 includes holes 133 receiving fasteners 134 to secure the truss bracket 132 to the longitudinal bottom rail 26. In the illustrated embodiment of FIG. 8, the truss bracket 132 is positioned in longitudinal alignment with a right-side of the bolster diagonal truss member 30. Further, in the illustrated embodiment of FIG. 8, the truss bracket 132 is positioned below the longitudinal axis A1, the diagonal truss member 30, and the holes 133 and fasteners 134. In other embodiments, the diagonal truss member 30 may be positioned at the same height or below the holes 133 and fasteners 134 that couple the truss bracket 132 to the longitudinal bottom rail 26. As illustrated in FIGS. 13A and 13B, the diagonal truss member 128 has opposite first and second ends that are shaped to facilitate connection with the bumper bracket 120 and truss bracket 132. Since the bumper bracket 120 and truss bracket 132 generally provide right angle cross-sections, the ends of the diagonal truss member 128 are flattened to provide at least two connection surfaces, each for engaging a different side surface of the bumper bracket 120 or truss bracket 132. The diagonal truss member 128 may absorb both axial (parallel to longitudinal axis A1) and lateral (parallel to axis A2) impact load of the impacting vehicle V2 and transmit the impact load to the longitudinal bottom rails 26 and the chassis 18. The diagonal truss member 128 is connected and oriented along its axis A3 to absorb impact of the impacting vehicle V2 in axial compression along the axis A3. Depending on force of the impact, the diagonal truss member 128 may deform forwardly, inwardly, and upwardly. Depending on the force and direction of the impact, the diagonal truss member 128 may deform in any one or more of the forward, inward, and upward directions. The diagonal truss member 128 may absorb more impact load in comparison to the vertical stabilizer 112.

In the illustrated embodiment of FIG. 7, the diagonal truss member 128 is more outwardly flared from the longitudinal axis A1 in comparison to the bolster diagonal truss member 30. The left hand side of FIG. 7 illustrates the bolster diagonal truss member 30 in dashed lines for better visibility of the diagonal truss member 128. The diagonal truss member 128 extends along the axis A3 which is angled forward, inward, and upward relative to the longitudinal axis A1. Only the forward and inward components of the axis A3 are visible in FIG. 7. The bolster diagonal truss member 30 extends along an axis A5 which is angled forward and inward relative to the longitudinal axis A1. In the illustrated embodiment, the axis A3 of the diagonal truss member 128 is oriented with its axis A3 more outwardly flared from the longitudinal axis A1 than the axis A5 of the bolster diagonal truss member 30. In other words, the bolster diagonal truss member 30 is oriented more forwardly (e.g., closer to parallel with the longitudinal axis A1) than the diagonal truss member 128. Conversely, the diagonal truss member 128 is oriented more inwardly (e.g., closer to parallel with the lateral axis A2) than the bolster diagonal truss member 30. This arrangement may, during a crash, promote the bolster diagonal truss member 30 to provide rigidity to the rear bolster 22 along the longitudinal axis A1 to a greater degree than the diagonal truss member 128 while permitting some axial deflection of the lateral ends of the bumper 104 along the longitudinal axis A1. However, other embodiments may arrange equal amounts of outward flare of the diagonal truss member 128 and to the bolster diagonal truss member 30. In other embodiments, the bolster diagonal truss member 30 may be more outwardly flared from the longitudinal axis A1 in comparison to the diagonal truss member 128.

In the illustrated embodiment and as best viewed in FIG. 13C, the diagonal truss member 128 is generally a hollow square in cross-sectional shape (a four-sided cross-section) perpendicular to the axis A3. The illustrated diagonal truss member 128 defines a side length of approximately 7.6 centimeters and a wall thickness of approximately 0.3 centimeters. The side length measured above is inclusive of the wall thicknesses of two opposing sides of the square cross-sectional shape. Excluding the wall thicknesses, the diagonal truss member 128 defines an inner dimension side length of approximately 7.0 centimeters. Further, the illustrated diagonal truss member 128 defines rounded edges curved about a radius taken perpendicular to the cross-section of approximately the same length as the wall thickness (0.3 centimeters) (e.g., defining an inner corner radius of approximately 0.3 centimeters and an outer corner radius including the wall thickness of approximately 0.6 centimeters). In this example, a cross-sectional area of the diagonal truss member 128 perpendicular to the axis A3 is approximately 8.69 centimeters squared. In this example, a cross-sectional area to wall thickness ratio of approximately 252 centimeters squared per centimeter (8.69 centimeters squared/0.3 centimeters). Other high cross-sectional area to wall thickness shapes may also be suitable for the diagonal truss member 128. For example, in other embodiments, a cross-sectional area to wall thickness ratio may be between 200 and 300, between 150 and 350, or between 100 and 400 centimeters squared per centimeter. Similar inverse wall thickness to cross-sectional area ratios correspond with the aforementioned cross-sectional area to wall thickness ratios. Such ratios may promote plastic axial deformation of the diagonal truss member 128 upon impact from the impacting vehicle V2 or other object and the rear impact guard 100 while also limiting weight of the rear impact guard 100.

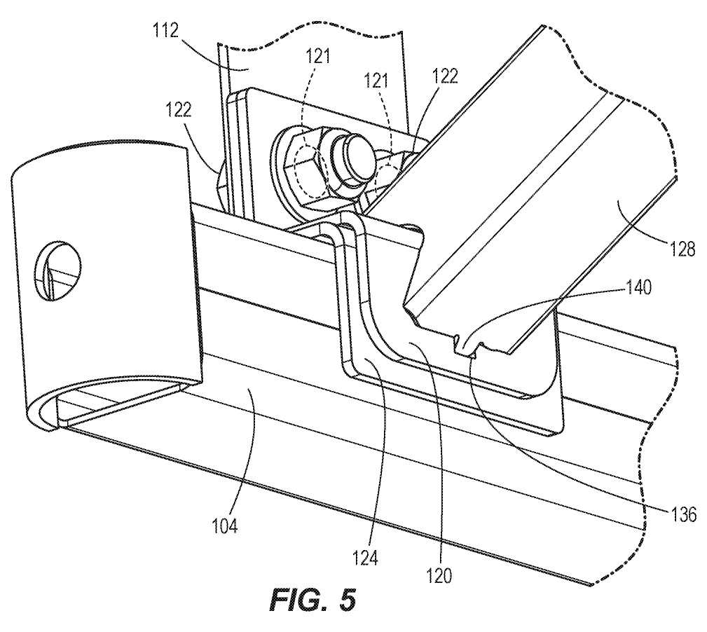

In the illustrated embodiment, length of the tabs 140 (e.g., approximately 1.5 centimeters) is approximately 20% of the side length of the diagonal truss member 128 (1.5 centimeters/7.6 centimeters, best illustrated in FIG. 5). This ratio may promote a secure connection between the tabs 140 and the slots 136. In other embodiments, length of at least one of the tabs 140, for example, at least one of the tabs of the diagonal truss member 128 may be between 10% and 30%, between 5% and 50%, or between 10% and 75% of the side length of the diagonal truss member 128. In other embodiments, the tabs 140 may be relatively wide correspond with at least 75% of the side length of the diagonal truss member 128, inclusive of 100% of the length of the diagonal truss member 128.

Further, in the illustrated embodiment, a tab length to wall thickness ratio between the length of the tabs 140 and the thickness of the walls defining the diagonal truss member 128 is approximately five (e.g., 1.5 cm/0.3cm). This ratio may promote secure connection between the slots 136 and tabs 140 and structural integrity of the tabs 140 themselves. In other embodiments, the tab length to wall thickness ratio may be between three and eight. In other embodiments, the tab length to wall thickness ratio may be between one and ten.

Various cross-sectional dimensions of the diagonal truss member 128 may differ. For example, other cross-sectional shapes for the diagonal truss member 128 may also be suitable. For example, FIG. 13D illustrates triangular (three-sided), pentagonal (five-sided), and circular (infinitely sided) cross-sectional shapes. In other embodiments, other outer dimensions may be considered in calculating the wall thickness to outer dimension ratio. For example, for circular cross-section diagonal truss members 128, The illustrated shapes are regular, hollow, and have closed profile shapes. However, other irregular cross-sectional shapes may also be suitable, as well as non-hollow cross-sectional shapes, and/or open profile shapes. For example, the diagonal truss member 128 may be shaped as an angle bracket (e.g., an L-shaped extrusion having two sides with two free ends), a C-channel (e.g., a C-shaped extrusion having three sides and two free ends, or a curved section having two free ends as shown in FIG. 13D), a solid bar or rod, or a flat plate. The diagonal truss member 128 may not have constant cross-section along its axis A3. The diagonal truss member 128 may be connected to additional structure between the bumper bracket 120 and the truss bracket 132. It is envisioned that other embodiments with hollow or non-closed diagonal truss members 128 may include one or more internal or external support webs, joints to further promote distribution of impact load to crushing of the diagonal truss member 128 along its axis A3. For example, the illustrated angle bracket (e.g., L-shaped) is illustrated in dashed lines with structural support webbing between each planar portion thereof. The support webbing may extend along a full length, a partial length, or intermittent portions of a length along the axis A3.

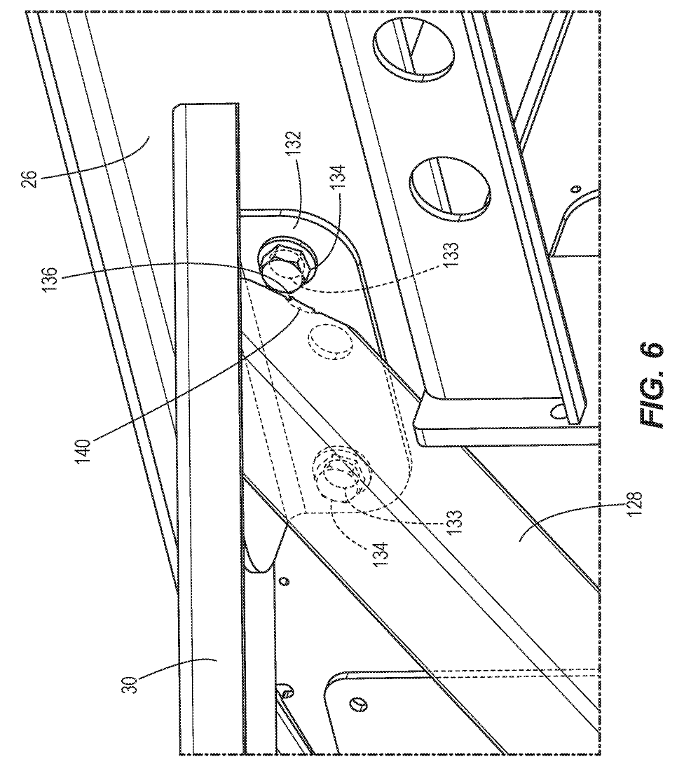

Components of the rear impact guard 100 such as the bolster bracket 116, bumper bracket 120, diagonal truss member 128, and truss bracket 132 include slots 136 and/or tabs 140 meshed with one another for further strengthening the connection points of the vertical stabilizer 112 and the diagonal truss member 128. As illustrated in FIGS. 12A-12C, the first plate 116a and second plate 116b of the bolster bracket 116 include slots 136, and the third plate 116c includes a plurality of tabs 140 at a periphery thereof. The illustrated slots 136 are positioned at a midpoint between lateral sides of the first plate 116a. The tabs 140 are received in the slots 136. Optionally, as illustrated in FIG. 12F and 13H, a weld B may further secure the tabs 140 in the slots 136. FIGS. 6 and 13H illustrate slots 136 and tabs 140 in the bumper bracket 120, diagonal truss member 128, and truss bracket 132. Tabs 140 in the illustrated embodiment are located on the third plate 116c and diagonal truss member 128. Slots 136 in the illustrated embodiment are located on the first plate 116a, second plate 116b, bumper bracket 120, and truss bracket 132. As connected by the slots 136 and tabs 140, the third plate 116c may bolster moment of inertia (resistance to twist in counter-clockwise direction as viewed in FIG. 10) of the first plate 116a. The vertical stabilizer 112 may also absorb impact by plastically deforming forwardly upon rear or offset rear impact from the impacting vehicle V2. With the slots 136 positioned at a midpoint between lateral sides of the first plate 116a and the third plate 116c coupled to the first plate 116a and third plate 116c, the bolster bracket 116 as a whole resembles an I-beam when viewed in parallel with the longitudinal axis A1. For example, the second plate 116b generally resembles the top flange of the I-beam, the first plate 116a generally resembles the bottom flange of the I-beam, and the third plate 116c resembles the web interconnecting the flanges. In other embodiments, the slots 136 and corresponding connection point provided by the tabs 140 may be positioned closer toward (e.g., an irregular I-beam with the web offset from lateral sides of the flanges) or at either lateral side of the first plate 116a (e.g., a C-beam or channel). Various other arrangements including slots 136 and tabs 140 are also possible.

With the tabs 140 and slots 136 further strengthening the connection points of the vertical stabilizer 112 and diagonal truss member 128, energy may be better absorbed by forward plastic deformation of the vertical stabilizer 112 and forward, upward, and inward plastic deformation of the diagonal truss member 128. In other words, the connection points are made less prone to fracture, and the rear impact guard 100 as a whole may better absorb offset rear impact from the impacting vehicle V2 by loading the impact in desired modes - forward deformation of the vertical stabilizer 112 and forward, upward, and inward deformation of the diagonal truss member 128.

In other embodiments, the slots 136 and tabs 140 arranged and/or positioned at differing locations to those illustrated. For example, more or fewer meshed pairs of slots 136 and tabs 140 may be provided. In other embodiments, the slots 136 and tabs 140 may be reversed, for example, with the diagonal truss member 128 including one or more slots 136, and the bumper bracket 120 including one or more tabs 140 (see FIG. 13H). In the illustrated embodiment, the tabs 140 are formed with the same wall thickness as the third plate 116c and diagonal truss member 128. In the illustrated embodiment, the tabs 140 extend along a length of approximately 1.5 centimeters (generally left to right as viewed in FIGS. 5, 12C, 13A, 13H), only along a portion of the third plate 116c and the diagonal truss member 128. In other embodiments, tabs 140 of other thickness and/or lengths are possible. For example, one or more of the tabs 140 may differ in thickness from the third plate 116c and/or the diagonal truss member 128. One or more of the tabs 140 may extend along a length between 1 centimeter and 2 centimeters, between 0.5 centimeters and 3 centimeters, or in excess of 3 centimeters.

As illustrated in FIGS. 12E-12G and 13E-13H, welds B may further secure components of the rear impact guard 100 including but not limited to the bolster bracket 116, bumper bracket 120, diagonal truss member 128, and truss bracket 132. Components of the rear impact guard 100 may be made of elastically and plastically deformable material, for example steel. The welds B may secure base metal from the components of the rear impact guard 100 (e.g., steel), and optionally filler metal.

FIG. 22 illustrates a finite element analysis (i.e., FEA) simulation of the rear impact guard 100 after an offset rear impact by a simulated impacting vehicle V2 (e.g., a midsize car), for example, in accordance with the May 2021 Version II Insurance Institute for Highway Safety (IIHS) underride evaluation crash test protocol at 30% overlap. The impacting vehicle V2 was simulated at an impact speed of approximately 56 kilometers per hour (i.e., 35 miles per hour) before impact. The simulated vehicle V1 had a total mass of a typical semi-trailer (e.g., approximately 18,700 kilograms, including the tractor, chassis 18, rear impact guard 100, and container C), and the simulated impacting vehicle V2 had a total mass of a typical passenger vehicle (e.g., a target mass of approximately 1700 kilograms, common for a midsize car). In the simulation, the vertical stabilizer 112 and bumper 104 were deformed forwardly, the bumper bracket 120 was opened up, and the diagonal truss member 128 was axially compressed along its longitudinal axis A3 and deformed, thereby shifting the diagonal truss member 128 to generally extending along a deformed axis A4 not coincident with axis A3. In the illustrated simulation, the diagonal truss member 128 crumpled at an end of the diagonal truss member 128 adjacent the bumper bracket 120 more than at the opposite end of the diagonal truss member 128 adjacent the truss bracket 132. In other situations, crumpling may occur at any axial position along the length of the diagonal truss member 128- for example, more crumpling may occur adjacent the truss bracket 132 than the bumper bracket 120.

Due to energy absorption via axial crushing along the axis A3 at the end of the diagonal truss member 128, buckling of the diagonal truss member 128 is avoided. By transmitting force to cause axial crushing of the diagonal truss member 128, shearing and/or fracture of the connection points of the rear impact guard 100, generally at the bolster bracket 116, bumper bracket 120, truss bracket 132 (and associated disassembly of the rear impact guard 100 whereby impact energy cannot be absorbed) is also avoided.

As a result of the impact, the bumper bracket 120 is extended and plastically deformed (i.e., “opened up” or “unfolded”) from its perpendicular three-portion (“Z”) shape illustrated in FIG. 17 at angles AN1, AN2 to deformation angles DA1 and DA2, respectively. In other words, the connection or joint between the rear bolster 22 and the bumper 104 at the location of the vertical stabilizer 112 and the diagonal truss member 128 is expandable in the event of a crash. The post-impact deformation angles DA1 and DA2 are both greater than the pre-impact angles AN1 and AN2 of the bumper bracket 120. The bumper bracket 120 itself effectively lengthened along the longitudinal axis A1 by rotationally plastically deforming the portions 120a-120c relative to one another, thereby increasing the angles AN1, AN2 to the deformation angles DA1, DA2. Plastic deformation of the bumper bracket 120 was completed while maintaining secure connection between diagonal truss member 128, the vertical stabilizer 112, and the bumper 104 to ensure load passage from the bumper bracket 120 to the diagonal truss member 128 and for plastic axial deformation thereof, with substantially no buckling of the diagonal truss member 128. The plastic deformation of the bumper bracket 120 can allow a substantial and predictable amount of movement of the end of the bumper 104 that maintains more axially directed impact load through the diagonal truss member 128, as opposed to side or offset loading. Fracture or tear-out are also avoided, within reasonable crash test limits.

With reference to FIGS. 2-4, a casting (e.g., twist-lock connector) 200 may be coupled to the rear bolster 22. The casting 200 can be used to facilitate connection between the chassis 18 and the cargo container C. A collar 204 may pass through or otherwise engage the casting 200, and a lock assembly 208 may be closed to promote connection between the collar 204 and the casting 200 and thus between the container C and the chassis 18. The lock assembly 208 includes a lock tab 209 that is pivotable relative to the casting 200 between locked and unlocked positions to facilitate connection to a corresponding lock receptacle of the cargo container C. The lock tab 209 is generally rectangularly shaped in cross section transverse to its pivoting direction A6. The lock tab 209 is illustrated in solid lines in rotational alignment with a mount 210. The mount 210 receives the lock receptacle of the cargo container C. After receipt of the lock receptacle in the mount 210, the lock assembly 208 is movable to its locked position by rotating the lock tab 209 to the lock tab locked position illustrated by reference numeral 209’ such that the lock tab 209’ holds the lock receptacle of the cargo container C between the casting 200 and the lock tab 209’. To further distribute impact load and during rear or offset crashes, and to promote high retention strength between the collar 204 with the casting 200, a washer 212 is provided between the collar 204 and the casting 200. The washer 212 effectively decreases load concentration of force from the collar 204 to the casting 200 by increasing an amount of surface area through which load can be passed from the collar 204 to the casting 200. This design promotes strong high retention strength between the collar 204 and the casting 200 while loads are transmitted during or after impact from the vehicle V2 to the rear impact guard 100 and associated load transfer between the cargo container C on vehicle V1 and the casting 200 through the lock assembly 208 and lock tab 209 thereof.

Various modifications may be made to the rear impact guard 100, and the rear impact guard 100 may be assembled with new vehicles V1 and/or chassis 18 or connected in a retrofit to existing vehicle V1 or chassis 18. Dimensions, sizing, and spacing of the bumper 104 and corresponding dimensions, sizing and spacing of the posts 108, vertical stabilizer 112, diagonal truss member 128, and associated brackets can be adjusted to retrofit various vehicles V1 having differing heights relative to the ground to ensure the bumper 104 is at proper height to relative to the ground for receiving impact from the impacting vehicle V2. Dimensions such as portion widths, heights, lengths, and thickness of the posts 108, vertical stabilizer 112, bumper bracket 120, optional intermediate bumper bracket 124, diagonal truss member 128, and truss bracket 132 may be adjusted as necessary to provide desired absorption and comport with geometric constraints. Similarly, material selection of components of the rear impact guard 100 may be adjusted as necessary to provide desired absorption and comport with geometric constraints. During retrofitting, various adjustments may be made to the rear bolster 22 and/or chassis 18 to facilitate connection of the rear impact guard 100 and/or other functionality. For example, the rear bolster 22 includes taillights 300. Material may be needed to be removed from the rear bolster 22 to facilitate connection of the second plate 116b to the rear bolster 22, and for providing different wiring passageways for the taillights 300.

The above-described rear impact guard 100, as incorporated with the chassis 18, has passed Insurance Institute for Highway Safety (i.e., IIHS) standardized testing associated with 30% overlap underride protection. The IIHS labels this testing as associated with “TOUGHGUARD.” Other dry van models have earned the “TOUGHGUARD” rating. However, no known chassis has earned the IIHS “TOUGHGUARD” rating. As mentioned in detail above, the illustrated rear impact guard 100 may be implemented as either attached to a standalone chassis 18 or as connected to a rear bolster of a “dry van” trailer. The Appendix submitted herewith includes further disclosure regarding IIHS standardized semitrailer underride evaluation crash test protocol.

Although the disclosure has been described in detail with reference to certain preferred embodiments, variations and modifications exist within the scope and spirit of one or more independent aspects of the disclosure as described.

What is claimed is:

1. A rear impact guard assembly attached to a trailer or chassis with a rear bolster extending in a lateral direction perpendicular with respect to a longitudinal direction of travel of the trailer or chassis, the rear impact guard assembly comprising:
a bumper with opposite lateral ends;
a post extending between the bumper and the rear bolster;
a vertical stabilizer coupled to the rear bolster by a bolster bracket and coupled to the bumper by a bumper bracket; and
a diagonal truss member with a first end thereof coupled to the bumper bracket and extending therefrom along an axis in a forward, inward and upward direction to a second end thereof, which is coupled to a truss bracket and the trailer or chassis;
wherein before impact between an object with the bumper, the diagonal truss member is in a pre-impact state having a first length along the axis;
wherein responsive to the impact, load of the impact is absorbed at least in part by plastic axial compression of the diagonal truss member along the axis; and
wherein after the impact, the diagonal truss member is in a deformed post-impact state having a second length along the axis that is shorter than the first length.

2. The rear impact guard assembly of claim 1, wherein at least one of the bolster bracket, bumper bracket, truss bracket, and diagonal truss member include either a tab or a slot meshed with a tab or a slot of another at least one of the bolster bracket, bumper bracket, the truss bracket, and the diagonal truss member.

3. The rear impact guard assembly of claim 2, wherein the meshed tab and slot contribute to strengthening at least one connection point between the at least one of the bolster bracket, bumper bracket, truss bracket, and diagonal truss member and the another at least one of the bolster bracket, bumper bracket, the truss bracket, and the diagonal truss member to promote absorption of impact load by the diagonal truss member.

4. The rear impact guard assembly of claim 3, wherein the meshed tab and slot promote absorption of impact load by the diagonal truss member by plastic axial compression.

5. The rear impact guard assembly of claim 1, wherein upon impact, the bumper bracket is dimensioned to plastically deform while maintaining secure connection between the diagonal truss member, the vertical stabilizer, and the bumper.

6. The rear impact guard assembly of claim 5, wherein the bumper bracket is a multi-portion bumper bracket defining a pre-impact angle between at least two portions thereof, and upon impact of the midsize car with the bumper, the pre-impact angle deforms to a deformation angle greater than the pre-impact angle.

7. The rear impact guard assembly of claim 1, wherein the bolster bracket includes
a first plate including portions extending downwardly, forwardly, diagonally upwardly, and upwardly;
a second plate being generally planar in parallel with the forwardly extending portion of the first plate; and
a third plate being generally planar in a direction perpendicular to the downwardly and upwardly extending portions of the first plate.

8. The rear impact guard assembly of claim 7, wherein at least one weld bead secures the first plate, second plate, and third plate to one another.

9. The rear impact guard assembly of claim 7, wherein at least one of the bolster bracket plates includes a slot and a different at least one of the bolster bracket plates includes a tab meshed with the slot.

10. The rear impact guard assembly of claim 9, wherein a weld bead secures the at least one bolster bracket plate to the different at least one of the bolster bracket plates by welding together the tab and the slot.

11. The rear impact guard assembly of claim 9, wherein the slot is positioned at a midpoint between lateral sides of the bolster bracket plate with the slot.

12. The rear impact guard assembly of claim 1, wherein the bolster bracket defines a hole that receives a fastener that couples the vertical stabilizer and the rear bolster.

13. The rear impact guard assembly of claim 1, wherein the bumper bracket defines a hole that receives a fastener that couples the vertical stabilizer and the bumper.

14. The rear impact guard assembly of claim 1, wherein the truss bracket defines a hole that receives a fastener that couples the diagonal truss member and the trailer or chassis.

15. The rear impact guard assembly of claim 1, wherein the object is a midsize car moving forward at 56 kilometers per hour in a direction parallel to the longitudinal direction toward the bumper with the bumper being stationary and with 30% of a width of the midsize car laterally overlapping the bumper.

16. A rear impact guard assembly attached to a trailer or chassis with a rear bolster extending in a lateral direction perpendicular with respect to a longitudinal direction of travel of the trailer or chassis, the rear impact guard assembly comprising:
a bumper with opposite lateral ends;
a post extending between the bumper and the rear bolster;
a vertical stabilizer coupled to the rear bolster by a bolster bracket and coupled to the bumper by a bumper bracket; and
a truss member with a first end thereof coupled to the bumper bracket and extending therefrom to a second end thereof, which is coupled to a truss bracket and the trailer or chassis;
wherein the bumper bracket is dimensioned such that upon impact of an object with the bumper, load of the impact deforms the bumper bracket to an expanded state.

17. The rear impact guard assembly of claim 16, wherein the bumper bracket includes
a first downwardly extending portion engaging the vertical stabilizer,
a forwardly extending portion engaging an upper surface of the bumper, and
a second downwardly extending portion engaging a forwardly facing surface of the bumper, thereby defining a first angle between the first downwardly extending portion and the forwardly extending portion and a second angle between the forwardly extending portion and the second downwardly extending portion.

18. The rear impact guard assembly of claim 17, wherein the impact causes deformation of at least one of the portions of the bumper bracket and thus deformation of at least one of the first angle and the second angle.

19. A rear impact guard assembly attached to a trailer or chassis with a rear bolster extending in a lateral direction perpendicular with respect to a longitudinal direction of travel of the trailer or chassis, the rear impact guard assembly comprising:
a bumper;
a post extending between the bumper and the rear bolster;
a connector casting and a collar configured to couple an external container to the trailer or chassis; and
a washer between the collar and the casting,
wherein upon impact of an object with the bumper, load of the impact is configured to be distributed from the collar and through the washer to the casting to promote high retention strength between the collar and the casting.

20. The rear impact guard assembly of claim 19, wherein the washer effectively decreases load concentration of force from the collar to the connector casting.
